(19) United States
(12) Patent Application Publication
(10) Pub. No.: US 2022/0144571 A1
(43) Pub. Date: May 12, 2022

(54) SHEET CONVEYANCE APPARATUS

(71) Applicant: CANON KABUSHIKI KAISHA, Tokyo (JP)

(72) Inventors: Shingo Iwami, Tokyo (JP); Yoshinao Chiba, Chiba (JP); Koji Suzuki, Chiba (JP); Yuma Inui, Ibaraki (JP); Yoshiya Numata, Ibaraki (JP)

(21) Appl. No.: 17/505,812

(22) Filed: Oct. 20, 2021

(30) Foreign Application Priority Data
Nov. 9, 2020 (JP) 2020-186739

(51) Int. Cl. B65H 9/00; B65H 7/02; B65H 9/16; B65H 5/36

(52) U.S. Cl. CPC B65H 9/004; B65H 7/02; B65H 9/166; G03G 15/6558; B65H 2301/161; B65H 2301/331; B65H 2601/272; B65H 5/36

(57) ABSTRACT

A sheet conveyance apparatus includes a conveyance roller, an abutment member including an abutment surface against which a side edge, in a width direction, of the sheet abuts, and configured to correct a skew of the sheet, an obliquely conveying roller configured to convey the sheet such as the side edge of the sheet is conveyed toward the abutment surface, a sheet side edge detection portion configured to detect a position of the side edge of the sheet, and a control unit configured to control that a conveyance force, in the width direction, by the obliquely conveying roller in response to a detection result of the sheet side edge detection portion becomes smaller than that in an abutment movement.

### BACKGROUND OF THE INVENTION

### Field of the Invention

This disclosure relates to a sheet conveyance apparatus conveying a sheet.

### Description of the Related Art

Japanese Patent Laid-Open No. H11-189355 suggests an image forming apparatus including a sheet feeding unit feeding a sheet, an alignment unit correcting a posture of a fed sheet, and a registration unit conveying the sheet with the posture corrected at the alignment unit to an image forming unit in a predetermined timing.

The alignment unit includes a reference guide extending along a sheet conveyance direction, an obliquely conveying roller conveying the sheet to the reference guide, a conveyance roller moving the sheet in a width direction orthogonal to a sheet conveyance direction, a sheet passage detection sensor detecting a position of a leading edge of the sheet, and a side edge detection sensor detecting a position of a side edge of the sheet.

To be noted, the obliquely conveying roller corrects a skew of the sheet by conveying the sheet along the reference guide. The conveyance roller moves the sheet in the width direction based on a detection signal of the side edge detection senser.

However, the alignment unit described in Japanese Patent Laid-Open No. H11-189355 does not take into consideration a timing of the completion of the skew correction performed by the obliquely conveying roller and the reference guide, and releases a nip of the obliquely conveying roller based on a detection timing of the sheet passage detection sensor.

Therefore, the obliquely conveying roller has conveyed the sheet while slipping over the sheet after the skew of the sheet has been corrected by being conveyed along the reference guide, during the time until the nip of the obliquely conveying roller is released. For example, in a case where a low stiffness sheet such as a thin paper is conveyed, there is a risk of buckling the sheet and causing conveyance failure. Further, in a case where a sheet with a surface coated, such as a coated paper is conveyed, there is a risk of peeling off a part of a coated layer on the sheet and causing image defects.

### SUMMARY OF THE INVENTION

The purpose of the present invention is to reduce conveyance failure of the sheet and image defects while properly correcting a skew of the sheet.

According to one aspect of the present invention, a sheet conveyance apparatus includes a conveyance roller configured to convey a sheet, an abutment member disposed downstream of the conveyance roller and extending along a sheet conveyance direction, the abutment member including an abutment surface against which a side edge, in a width direction orthogonal to the sheet conveyance direction, of the sheet abuts, and configured to correct a skew of the sheet, an obliquely conveying roller disposed downstream of the conveyance roller in the sheet conveyance direction, and configured to convey the sheet such as the side edge of the sheet is conveyed toward the abutment surface, a sheet side edge detection portion configured to detect a position of the side edge of the sheet in the width direction and change an output value in response to the position of the side edge of the sheet conveyed by the obliquely conveying roller, and a control unit configured to control that a conveyance force, in the width direction, by the obliquely conveying roller in response to a detection result of the sheet side edge detection portion becomes smaller than that in an abutment movement, the abutment movement being a movement in which the side edge of the sheet is brought to abut against the abutment surface by the obliquely conveying roller conveying the sheet.

Further features of the present invention will become apparent from the following description of exemplary embodiments with reference to the attached drawings.

### BRIEF DESCRIPTION OF THE DRAWINGS

FIG. 1 is an entire schematic diagram showing a printer relating to a first embodiment.

FIG. 2 is a schematic diagram showing a registration unit relating to the first embodiment.

FIG. 3 is a control block diagram of the printer relating to the first embodiment.

FIG. 4 is a flowchart showing an abutment movement performed by the registration unit.

FIG. 5A is a diagram showing the sheet conveyance performed by a conveyance roller portion of the registration unit.

FIG. 5B is a diagram showing a state where a sheet has entered an obliquely conveying roller portion of the registration unit.

FIG. 6A is a diagram showing the sheet conveyance performed by the obliquely conveying roller portion of the registration unit.

FIG. 6B is a diagram showing a state where a side edge of the sheet abuts on an abutment surface of an abutment member of the registration unit.

FIG. 7 is a graph illustrating a judgement about the completion of the abutment movement of the sheet performed by the registration unit.

FIG. 8A is a diagram showing an example of a case where the side edge of the sheet whose skew has not been corrected by the registration unit is positioned inside a predetermined area.

FIG. 8B is a diagram showing a state of the sheet in the middle of the skew correction by the registration unit.

FIG. 9A is a flowchart showing operations performed at the time of the completion of the abutment movement by the registration unit.

FIG. 9B is a flowchart showing operations performed at the time when the abutment movement by the registration unit has not been completed.

FIG. 10 is a diagram showing a message displayed in a display part.

FIG. 11A is a flowchart showing an operation performed at the time when the abutment movement relating to a second embodiment has been completed.

FIG. 11B is a flowchart showing an operation performed at the time when the abutment movement relating to a third embodiment has been completed.

FIG. 11C is a flowchart showing operations performed at the time when the abutment movement relating to a fourth embodiment has not been completed.

FIG. 12A is a diagram showing a state where a skewed sheet has reached a registration roller pair.

FIG. 12B is a diagram showing a state where a bent sheet has reached the registration roller pair.

FIG. 13A is a diagram showing a sheet with image defects occurred.

FIG. 13B is a diagram showing the sheet with the image defects occurred.

FIG. 13C is a diagram showing a sheet with printing performed properly.

### DESCRIPTION OF THE EMBODIMENTS

### First Embodiment

### General Arrangement

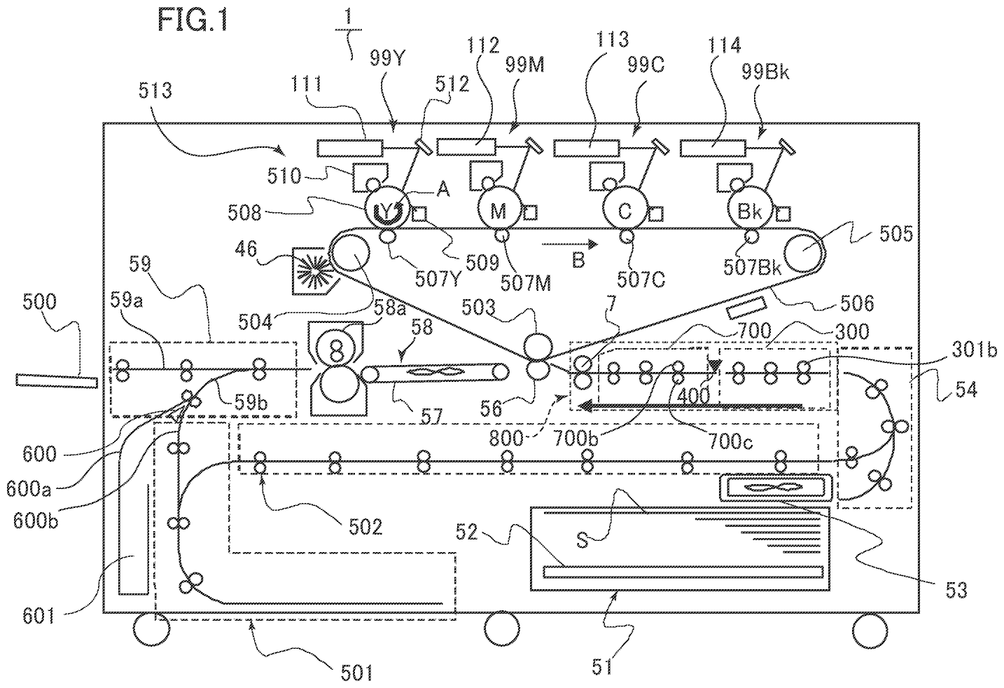

At first, a first embodiment of this disclosure will be described. A printer 1, serving as an image forming apparatus, is a full color laser beam printer of an electrophotographic system. As shown in FIG. 1, the printer 1 includes a sheet feed unit 51, a conveyance unit 54, a registration unit 800, an image forming unit 513, a fixing unit 58, and a branch conveyance unit 59. Further, the printer 1 includes an inversion conveyance unit 501, a duplex conveyance unit 502, a sheet discharge tray 500, and an escape tray 601.

The image forming unit 513 includes four process cartridges 99Y, 99M, 99C, and 99Bk forming toner images of four colors, yellow (Y), magenta (M), cyan (C), and black (K), and exposing units 111, 112, 113, and 114. To be noted, configurations of four process cartridges 99Y, 99M, 99C, and 99Bk are the same except for colors in which the images are formed. Therefore, only the configuration and an image forming process of the process cartridge 99Y will be described, and descriptions of the process cartridges 99M, 99C, and 99Bk will be omitted herein.

The process cartridge 99Y includes a photosensitive drum 508, a charge roller, a developing unit 510, and a cleaner 509. The photosensitive drum 508 is constructed by coating an organic photoconductive layer on an outer circumferential surface of an aluminum cylinder, and rotatably driven by a driving motor. Further, an intermediate transfer belt 506 rotatably driven in an arrow B direction by a driving roller 504 is disposed in the image forming unit 513, and is wound around a tension roller 505, the driving roller 504, and a secondary transfer inner roller 503. Inside the intermediate transfer belt 506, primary transfer rollers 507Y, 507M, 507C, and 507Bk are disposed, and, outside the intermediate transfer belt 506, a secondary transfer outer roller 56 is disposed opposite the secondary transfer inner roller 503.

The fixing unit 58 includes a fixing roller pair 58a and a pre-fixing conveyance unit 57 conveying the sheet to a nip of the fixing roller pair 58a. The sheet feed unit 51 includes a lift plate 52 ascending and descending while stacking a sheet S, and a pneumatic sheet feed unit 53 feeding the sheet S stacked on the lift plate 52. The pneumatic sheet feed unit 53 sorts the sheet stacked on the lift plate 52 pneumatically, and conveys an uppermost sheet on the lift plate 52 while sucking with air. To be noted, in place of the pneumatic sheet feed unit 53, it is acceptable to apply the other sheet feed units such as a roller and a belt.

Next, an image forming operation of the printer 1 configured as described above will be described. When an image signal is input to the exposing unit 111 from a personal computer and the like, a laser beam is irradiated onto the photosensitive drum 508 from the exposing unit 111 corresponding to the image signal.

At this time, a surface of the photosensitive drum 508 has been uniformly charged in a predetermined polarity and electric potential beforehand by the charge roller, and an electrostatic latent image is formed on the surface with the laser beam irradiated by the exposing unit 111 via a mirror 512. The electrostatic latent image formed on the photosensitive drum 508 is developed by the developing unit 510, and the toner image of yellow (Y) is formed on the photosensitive drum 508.

Similarly, the photosensitive drums of the process cartridges 99M, 99C, and 99Bk are respectively irradiated with the laser beam by the exposing units 112, 113, and 114, and the toner images of magenta (M), cyan (C), and black (K) are formed on each of the photosensitive drums. Each color of the toner images formed on each of the photosensitive drums is transferred to the intermediate transfer belt 506 by the primary transfer rollers 507Y, 507M, 507C, and 507Bk. Then, a full color toner image is conveyed by the intermediate transfer belt 506 rotatably driven by the driving roller 504 to a secondary transfer nip T2 formed by the secondary transfer inner roller 503 and the secondary transfer outer roller 56. A residual toner remained on the photosensitive drum 508 is collected by the cleaner 509. To be noted, the image forming process of each color is performed in a timing superimposing the toner image on an upstream toner image primarily transferred onto the intermediate transfer belt 506.

In parallel with this image forming process, the sheet S is fed from the sheet feed unit 51, and conveyed to the registration unit 800 by the conveyance unit 54. After a skew has been corrected by registration unit 800, the sheet S is conveyed to the secondary nip T2, serving as an image forming portion, in a predetermined conveyance timing. The full color toner image on the intermediate transfer belt 506 is transferred onto a first sheet surface (front surface) of the sheet S by applying a secondary transfer bias to the secondary transfer outer roller 56. A residual toner remained on the intermediate transfer belt 506 is collected by a belt cleaner 46.

The sheet S onto which the toner image has been transferred is conveyed to the fixing roller pair 58a by the pre-fixing conveyance unit 57. Then, the sheet S is provided with predetermined heat and pressure by the fixing roller pair 58a, so that a toner is melted and bonded (fixed). The branch conveyance unit 59 performs path selection selecting a conveyance path for the sheet S passed through the fixing unit 58 between a first discharge path 59a and a second discharge path 59b.

In a case where the image is formed on only one of the surfaces of the sheet S, the sheet S is conveyed from the branch conveyance unit 59 to the first discharge path 59a, and discharged to the sheet discharge tray 500, serving as a first tray.

In a case where the image is formed on both surfaces of the sheet S, the sheet S is conveyed to the second discharge path 59b by the branch conveyance unit 59. Then, a guide member 600 performs a path selection selecting a conveyance path for the sheet S conveyed to the second discharge path 59b between an escape path 600a and an inversion path 600b. The sheet S guided to the escape path 600a by the guide member 600 is discharged to the escape tray 601. For example, the sheet S which is not usable as deliverables due to image defects and the like is discharged to the escape tray 601.

The conveyance of the sheet S conveyed to the inversion path 600b is switchbacked in the inversion conveyance unit 501. The switchbacked sheet S is conveyed from the inversion conveyance unit 501 to the duplex conveyance unit 502, and guided to the conveyance unit 54. Thereafter, the image is formed on a second sheet surface (back surface) of the sheet S at the secondary transfer nip T2, and the sheet S is discharged to the sheet discharge tray 500.

### Registration Unit

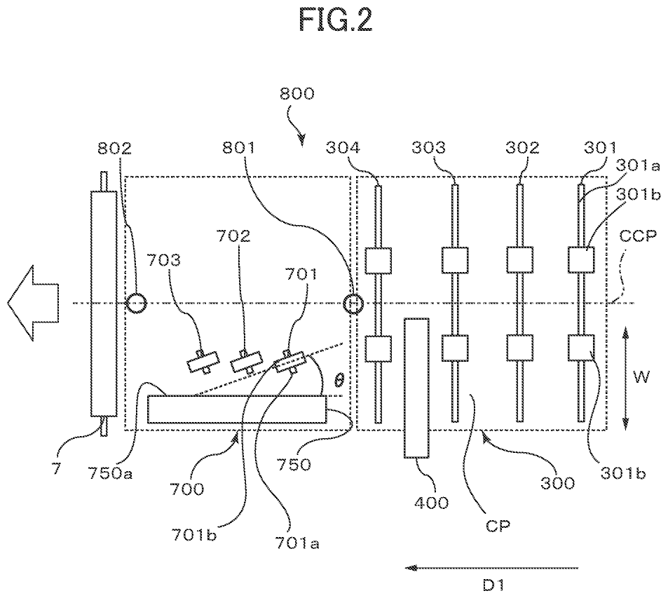

Next, using FIG. 2, the registration unit 800 in FIG. 1 will be described. The registration unit 800 includes a conveyance roller portion 300, an obliquely conveying roller portion 700, a registration roller pair 7, a reference member 750 serving as a abutment member, a CIS 400, a first pre-registration sensor 801, and a second pre-registration sensor 802. The CIS 400 is constructed by a contact image sensor.

The conveyance roller portion 300 includes a plurality (4 pairs in this embodiment) of conveyance roller pairs 301, 302, 303, and 304. These conveyance roller pairs 301 to 304 are disposed parallel to each other in a sheet conveyance direction D1, and similar in a configuration to each other. For example, the conveyance roller pair 301 includes a rotation shaft 301a, serving as a first rotation shaft extending in a width direction W, and roller portions 301b and 301b, serving as first rotary members rotatably supported by the rotation shaft 301a. The width direction W, as an axial direction, orthogonally intersects with the sheet conveyance direction D1.

The obliquely conveying roller portion 700 includes a plurality (3 pairs in this embodiment) of obliquely conveying roller pairs 701, 702, and 703. These obliquely conveying roller pairs 701 to 703 are disposed parallel to each other in the sheet conveyance direction D1, and similar in a configuration to each other. For example, the obliquely conveying roller pair 701 includes a rotation shaft 701a, serving as a second rotation shaft extending in a direction intersecting with the sheet conveyance direction D1 and the width direction W, and a roller portion 701b, serving as a second rotary member rotatably supported by the rotation shaft 701a. The obliquely conveying roller pair 701 is disposed downstream of the conveyance roller pair 301 in the sheet conveyance direction D1.

A radial direction of the roller portion 701b inclines to an abutment surface 750a of the reference member 750 by an angle Θ, and the roller portion 701b is configured to convey the sheet S toward the abutment surface 750a. The skew of the sheet S is corrected by abutting an edge in the width direction W on the abutment surface 750a.

The CIS 400, serving as a sheet side edge detection portion, is disposed between the conveyance roller pairs 303 and 304 in the sheet conveyance direction D1. Further, the CIS 400 is disposed on one side with respect to the center line CCP of a conveyance path CP through which the sheet S passes. The CIS 400 changes an output value depending on a position of the edge of the sheet S in the width direction W, so that it is possible to detect the position of the edge of the sheet S in the width direction W. To be noted, a disposition of the CIS 400 is not limited to this. Further, the CIS 400 is not limited to the contact image sensor, and it is acceptable to apply a variety of sensors of a contact type and a non-contact type. For example, in place of the CIS 400, it is acceptable to apply a flag sensor and a photo sensor of a transmitting type or a reflection type.

The first and second pre-registration sensors 801 and 802 are disposed on the center line CCP. The first pre-registration sensor 801 is disposed between the conveyance roller pair 304 and the obliquely conveying roller pair 701 in the sheet conveyance direction D1, and the second pre-registration sensor 802 is disposed downstream of the obliquely conveying roller pairs 701, 702 and 703 in the sheet conveyance direction D1. These first and second pre-registration sensors 801 and 802 each are photo sensors having a light emitting component and a photosensing portion, and detect a timing of the passage of the sheet S by receiving the light emitted by the light emitting component and reflected by the sheet S by the photosensing portion.

The registration roller pair 7 is capable of aligning a position of the toner image formed on the intermediate transfer belt 506 with a position of the sheet S in the width direction W by moving in the width direction W with the sheet S nipped.

### Control Block

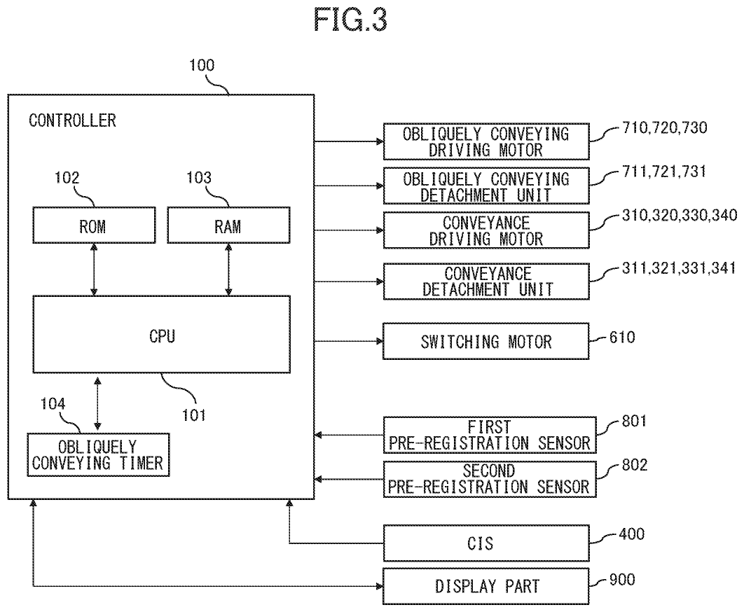

Next, using FIG. 3, a control block of the printer 1 will be described. As shown in FIG. 3, the printer 1 includes a controller 100, and the controller 100, serving as a control unit, includes a CPU (central processing unit) 101, a ROM (read-only memory) 102, a RAM (random-access memory) 103, and an obliquely conveying timer 104. The CPU 101 controls each unit of the printer 1 by reading various programs stored in the ROM 102. The RAM 103 is used as a work area of the CPU 101. The obliquely conveying timer 104 is capable of counting time.

The CIS 400, the first and second pre-registration sensors 801 and 802, obliquely conveying driving motors 710, 720, and 730, and obliquely conveying detachment units 711, 721, and 731 are coupled to the controller 100. Further, conveyance driving motors 310, 320, 330, and 340 and conveyance detachment units 311, 321, 331, and 341, a switching motor 610, and a display part 900 are coupled to the controller 100.

The obliquely conveying driving motors 710, 720, and 730 respectively drives the obliquely conveyance roller pairs 701, 702, and 703. The obliquely conveying detachment units 711, 721, and 731 respectively move one or both of a pair of rollers constituting the obliquely conveying roller pairs 701, 702, and 703 in a direction coming into contact with or being separated from each other. To be noted, in this embodiment, driven rollers of the obliquely conveying roller pairs 701, 702, and 703 are configured to come into contact with or to be separated from driving rollers.

The conveyance driving motors 310, 320, 330, and 340 respectively drive the conveyance roller pairs 301, 302, 303, and 304. The conveyance detachment units 311, 321, 331, and 341 move one or both of a pair of rollers constituting the conveyance roller pairs 301, 302, 303, and 304 in a direction coming into contact with or being separated from each other. To be noted, in this embodiment, driven rollers of the conveyance roller pairs 301, 302, 303, and 304 are configured to come into contact with or to be separated from driving rollers.

The switching motor 610 is capable of swinging the guide member 600, and capable of switching the conveyance path of the sheet S between the escape path 600a and the inversion path 600b. The display part 900 is capable of displaying a screen.

### Abutment Movement of Sheet

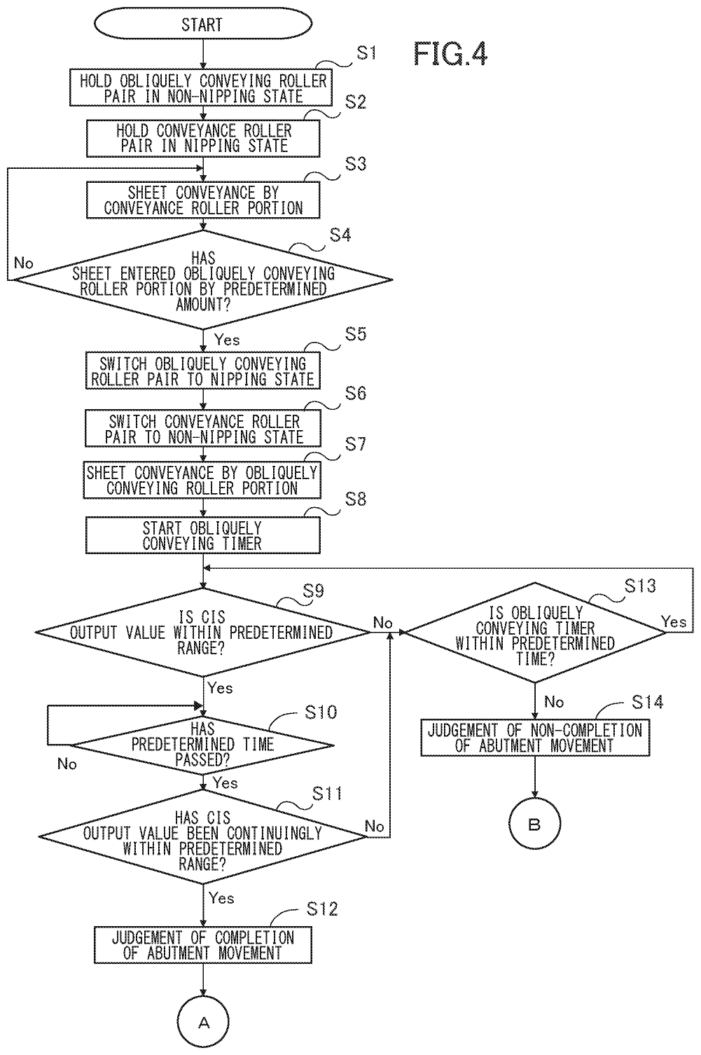

Next, using a flowchart in FIG. 4, an abutment movement of the sheet S on the abutment surface 750a will be described. The abutment movement is a movement in which the side edge Sa of the sheet S is brought to abut against the abutment surface 750a by the obliquely conveying roller pairs 701, 702, and 703 conveying the sheet S. As shown in FIG. 4, at first, the controller 100 holds the obliquely conveying roller pairs 701, 702, and 703 in a non-nipping state by the obliquely conveying detachment units 711, 721, and 731 (STEP 51). Further, the controller 100 holds the conveyance roller pairs 301, 302, 303, and 304 in the nipping state by the conveyance detachment units 311, 321, 331, and 341 (STEP S2). To be noted, the non-nipping state is a state in which a pair of rollers are separated from each other so as to release a nip, and a nipping state is a state in which the pair of rollers come into contact with each other so as to form the nip.

Then, the conveyance roller portion 300 conveys the sheet S by the conveyance roller pairs 301, 302, 303, and 304, which are in the nipping state, by being driven by the conveyance driving motors 310, 320, 330, and 340 (STEP S3). Next, the controller 100 judges based on a detection result of the first pre-registration sensor 801 whether or not the sheet S has entered the obliquely conveying roller portion 700 by a predetermined amount (STEP S4).

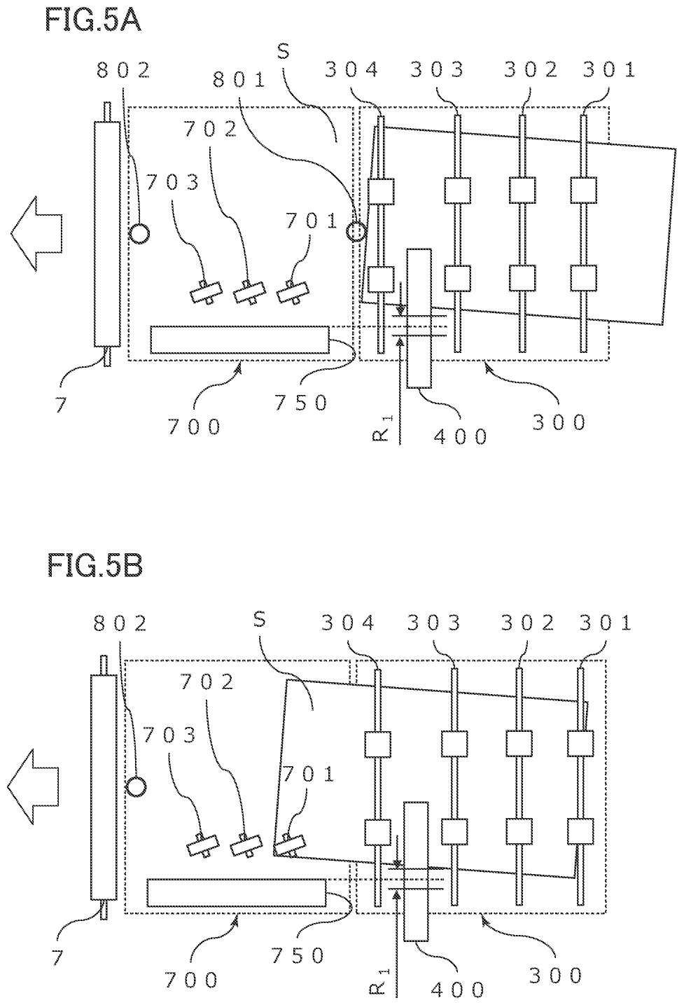

In a case where it is judged that the sheet S has not entered the obliquely conveying roller portion 700 by the predetermined amount (STEP S4: No), the controller 100 returns to STEP S3. As shown in FIG. 5B, in a case where it is judged that the sheet S has entered the obliquely conveying roller portion 700 by the predetermined amount (STEP S4: Yes), the controller 100 switches the obliquely conveying roller pairs 701, 702, and 703 to the nipping state (STEP S5). Further, the controller 100 switches the conveyance roller pairs 301, 302, 303, and 304 to the non-nipping state by the conveyance detachment units 311, 321, 331, and 341 (SPEP S6). To be noted, it is acceptable to stop the conveyance roller pairs 301, 302, 303, and 304 at this time by stopping driving the conveyance driving motors 310, 320, 330, and 340.

Then, the obliquely conveying roller portion 700 conveys the sheet S by the obliquely conveying roller pairs 701, 702, and 703 by being driven by the obliquely conveying driving motors 710, 720, and 730 (STEP S7). At this time, by starting counting a time with the obliquely conveying timer 104, the controller 100 starts counting a conveyance time of the sheet S by the obliquely conveying roller portion 700 (hereinafter referred to as an obliquely conveying time) (STEP S8).

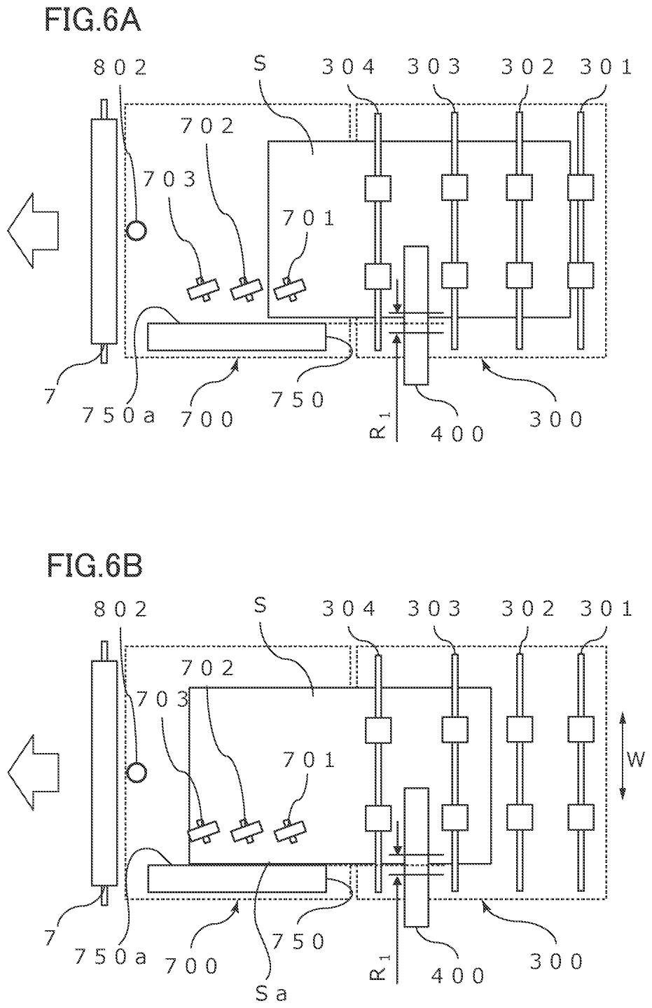

Then, as shown in FIGS. 6A and 6B, the sheet S is conveyed toward the abutment surface 750a of the reference member 750. When a side edge Sa of the sheet S in the width direction W is conveyed after the abutment surface 750a, the skew of the sheet S is corrected. With the side edge Sa of the sheet S being after the abutment surface 750a, the side edge Sa is positioned inside a predetermined range R₁ at a position of the CIS 400. The predetermined range R₁ is, for example, an area which is within 0.3 mm with respect to a position of the abutment surface 750a in the width direction W.

As shown in FIG. 4, next, the controller 100 judges whether or not a position of the side edge Sa of the sheet S detected by the CIS 400 is inside the predetermined range R₁ (STEP S9). In a case where the side edge Sa is inside the predetermined range R₁ (STEP S9: Yes), the controller 100 waits the passing of a predetermined time t₁ (STEP S10). In this embodiment, the predetermined time t₁ is about 50 msec (millisecond). Then, when the predetermined time t₁ has passed (STEP S10: Yes), the controller 100 judges whether or not the position of the side edge Sa of the sheet S detected by the CIS 400 has been continuingly inside the predetermined range R₁ during the predetermined time t₁ (STEP S11).

In a case where the position of the side edge Sa has been continuingly inside the predetermined range R₁ (STEP S11: Yes), the controller 100 judges that the abutment movement of the sheet S on the abutment surface 750a has been completed (STEP S12). In other words, in a case where an output value of the CIS 400 has continued to be inside the predetermined range R₁ during the predetermined time t₁, the controller 100 judges that the abutment movement of the sheet S on the abutment surface 750a has been completed.

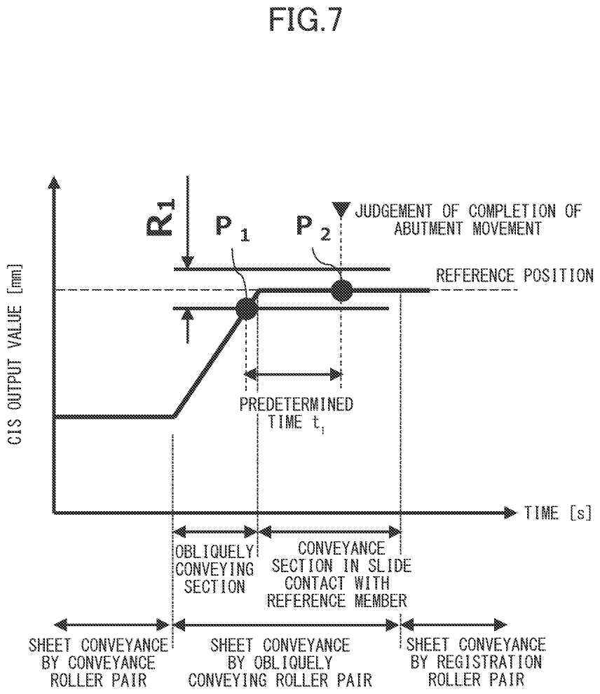

At this point, using FIG. 7, STEPS S7 to S12 will be described in detail. FIG. 7 is a graph with time on the horizontal axis and the output value of the CIS 400 on the vertical axis. The time on the horizontal axis is counted by the obliquely conveying timer 104. Having been conveyed by the conveyance roller pairs 301 to 304 at first (refer to STEP S3), the sheet S is conveyed by the obliquely conveying roller pairs 701 to 703 (obliquely conveying section; refer to STEP S7). When the sheet S is conveyed by the obliquely conveying roller pairs 701 to 703, the position of the side edge Sa detected by the CIS 400 (hereinafter referred to as a detection position) gradually approaches the position of the abutment surface 750a of the reference member 750 in the width direction W (hereinafter referred to as a reference position 750R).

Then, the predetermined time t₁ is counted from the time P₁ when the detection position described above has entered the predetermined range R₁ (refer to STEPS S9 and S10). When the detection position further approaches the reference position 750R and the side edge Sa comes into slide contact with the abutment surface 750a, the detection position is maintained at the reference position 750R (reference member slide contact conveyance section).

In a case where the detection position is inside the predetermined range R₁ at the time P2 when the predetermined time t₁ has passed from the time P₁, the controller 100 judges that the abutment movement of the sheet S on the abutment surface 750a has been completed (refer to STEPS S11 and S12). While, in this embodiment, the time P₂ is the time when the predetermined time t₁ has passed from the time P₁, it is not limited to this. For example, it is acceptable that the time P₂ is the time when the sheet S has been conveyed by as much as a predetermined distance. Further, it is acceptable that, depending on expected printing precision and a sheet size, the predetermined range R₁ and the predetermined time t₁ are suitably set at default values beforehand or provided to be settable by a user.

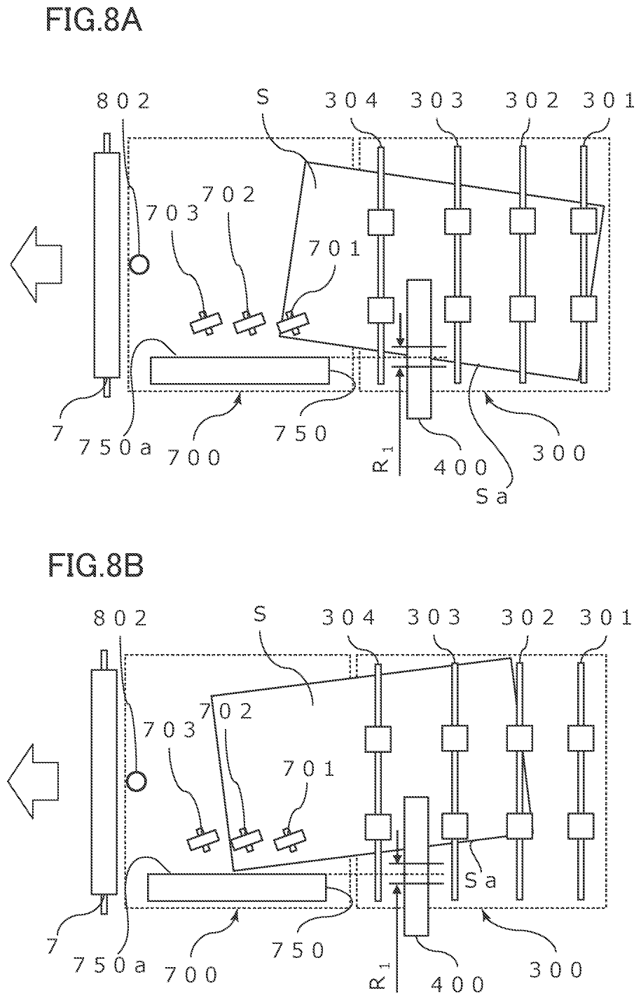

To be noted, because of following reasons, the detection positions from the time t₁ to the time P₂ when the predetermined time t₁ has passed from the time P₁ are used for the judgement of the completion of the abutment movement as described above. For example, a case where the sheet S is conveyed by the conveyance roller portion 300 in a posture as shown in FIG. 8A and delivered to the obliquely conveying roller portion 700 is considered.

In FIG. 8A, while the side edge Sa of the sheet S is positioned inside the predetermined range R₁, at this time, the side edge Sa of the sheet S does not come into slide contact with the abutment surface 750a of the reference member 750, and the skew of the sheet S is not corrected. Therefore, if, based on a detection result that the side edge Sa of the sheet S is inside the predetermined range R₁ at a time of FIG. 8A, it is judged that the abutment movement has been completed, it leads to an erroneous judgement.

Further, for example, when the predetermined time t₁ has passed from the time of FIG. 8A, the posture of the sheet S becomes a posture as shown in FIG. 8B by being conveyed by the obliquely conveying roller portion 700. At a time of FIG. 8B, the sheet S is still in the middle of the abutment movement, and the side edge Sa of the sheet S is outside the predetermined range R₁. As described above, by detecting the positions of the side edge Sa of the sheet S not only at the time of FIG. 8A but also at the time of FIG. 8B, it is possible to reduce the erroneous judgement on the completion of the abutment movement.

As shown in FIG. 4, in a case where the position of the side edge Sa detected by the CIS 400 is outside the predetermined range R₁ in STEP S9 (STEP S9: No), the controller 100 judges whether or not the time counted by the obliquely conveying timer 104 is within the predetermined time (STEP S13). In a case where the time counted by the obliquely conveying timer 104 is within the predetermined time (STEP S13: Yes), the controller 100 returns to SPEP S9.

In a case where the time counted by the obliquely conveying timer 104 is not within the predetermined time (STEP S13: No), the controller 100 judges that the abutment movement has not been completed (STEP S14). That is, in a case where the side edge Sa has not come inside the predetermined range R₁ within the predetermined time after the obliquely conveying timer 104 started counting the time, the controller 100 judges that the abutment movement has not been completed.

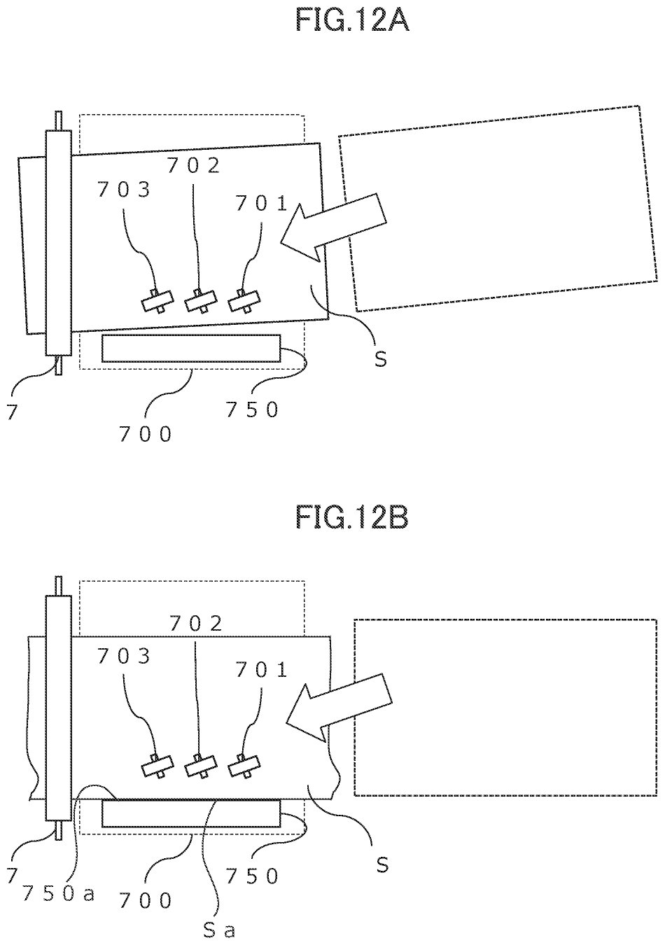

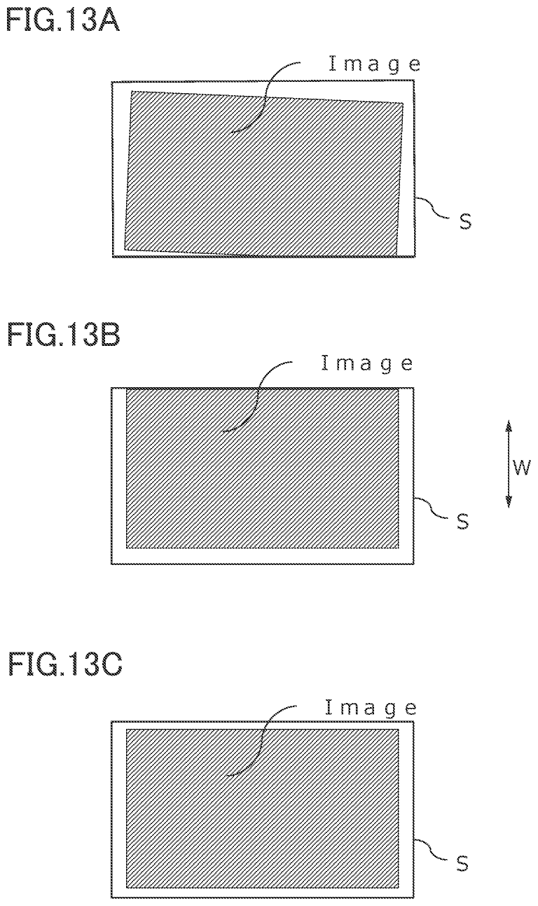

Here, using FIGS. 12A to 13C, reference examples of the image defects caused by the skew of the sheet S will be described. For example, a case in which a deliverable (printed matter) as shown in FIG. 13C has been anticipated is considered. If, as shown in FIG. 12A, the sheet S has reached the registration roller pair 7 before abutting on the reference member 750, the image printed on the sheet S inclines as shown in FIG. 13A.

Further, if, as shown in FIG. 12B, the side edge Sa is continued to be pressed to the abutment surface 750a by the obliquely conveying roller pairs 701, 702, and 703 even after the skew of the sheet S has been corrected by abutting on the abutment surface 750a of the reference member 750, the sheet S is bent in some cases. This often occurs especially in a case of a low stiffness sheet such as a thin sheet. Then, the sheet S reaches the registration roller pair 7 in a bent state, and, as shown in FIG. 13B, the image is printed on the sheet S with the image shifted to one side in the width direction W. As described above, in a case where it is not judged that the abutment movement has been completed, there is a risk of the occurrence of the image defects.

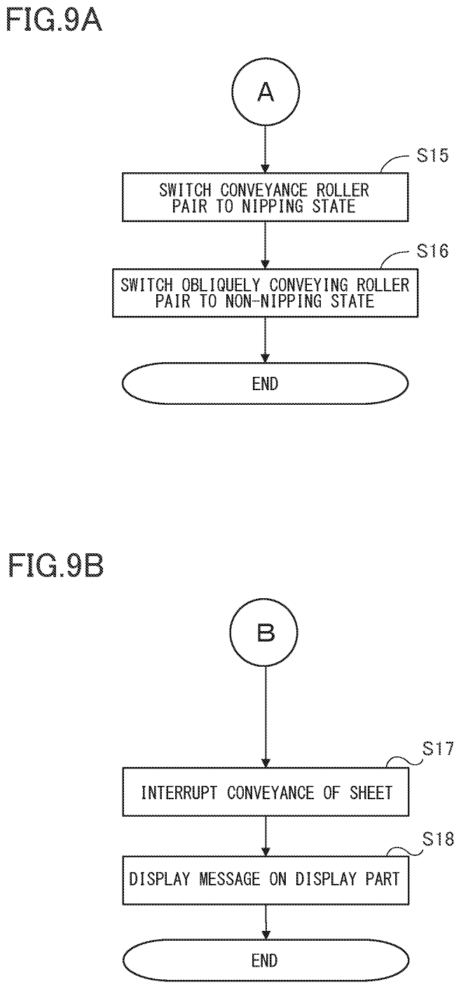

On the other hand, in this embodiment, it is possible to infallibly judge the completion and non-completion of the abutment movement of the sheet S by the use of the CIS 400. In a case where it is judged at STEP S12 that the abutment movement has been completed, the following operations are performed. That is, as shown in FIG. 9A, the controller 100 switches a part or all of the conveyance roller pairs 301, 302, 303, and 304 to the nipping state by the conveyance detachment units 311, 321, 331, and 341 (STEP S15).

Further, the controller 100 switches the obliquely conveying roller pairs 701, 702, and 703 to the non-nipping state by the obliquely conveying detachment units 711, 721, and 731 (SPEP S16). For example, the controller 100 performs a separating action of moving the roller portion 701b of the obliquely conveying roller pair 701 in a separation direction from the sheet S. As shown in FIG. 1, the obliquely conveying roller pair 701 includes a roller portion 701c, serving as a third rotary member, which forms a nip with the roller portion 701b and conveys the sheet while nipping at the nip. The separating action above is an action of separating the roller portion 701b from the roller portion 701c and release the nip. That is, a conveyance force, in the width direction W, by the obliquely conveying roller pairs 701, 702, and 703 becomes smaller than that in the abutment movement.

Herewith, it is possible to convey the sheet S in the sheet conveyance direction D1 by the conveyance roller portion 300 again, and possible to prevent the sheet S from excessively abutting on the reference member 750. Therefore, since it is possible to reduce a force which the sheet S receives from the abutment surface 750a of the reference member 750, it is possible to suppress the damage to and the bent of the sheet S and suppress the image defects.

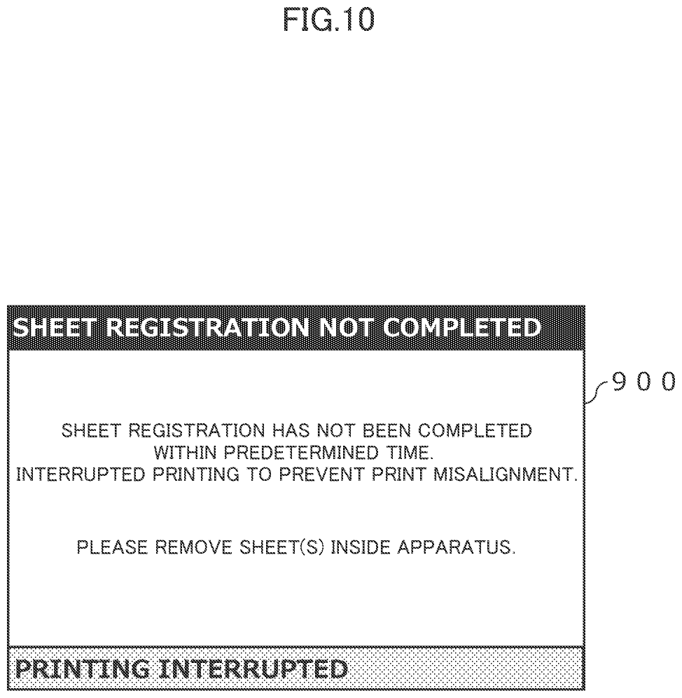

Further, in a case where it is judged at S IEP S14 that the abutment movement has not been completed, as shown in FIG. 9B, the controller 100 interrupts the conveyance of the sheet S by the printer 1 (STEP S17). Thereafter, as shown in FIG. 10, the controller 100 displays on the display part 900, serving as an informing portion, a message informing the non-completion of the abutment movement (STEP S18). Further, such message transmits a possibility of the occurrence of the image defects (print misalignment) due to the non-completion of the abutment movement and a stop of the sheet conveyance to the user, and urges the user to remove the sheet remained inside the printer 1.

To be noted, this kind of message is not limited to the message as shown in FIG. 10, and any message will be used. Further, it is acceptable to transmit the non-completion of the abutment movement to the user by flickering of a lamp, a warning sound, or the like instead of displaying the message on the display part 900. That is, in a case where it is judged that the abutment movement has not been completed within the predetermined time after the obliquely conveying roller pairs 701 to 703 started the conveyance of the sheet, the informing portion such as the display part 900, the lamp, and a buzzer is activated.

As described above, in this embodiment, it is possible to infallibly judge the completion and non-completion of the abutment movement of the sheet S in response to the detection result of the CIS 400, and possible to reduce conveyance failure and the image defects by properly correcting the skew of the sheet S.

### Second Embodiment

While a second embodiment will be described next, the second embodiment is different from the first embodiment only in the control performed at the time of the completion of the abutment movement. Therefore, configurations similar to the first embodiment will be described by omitting illustrations or by putting the same reference characters on drawings.

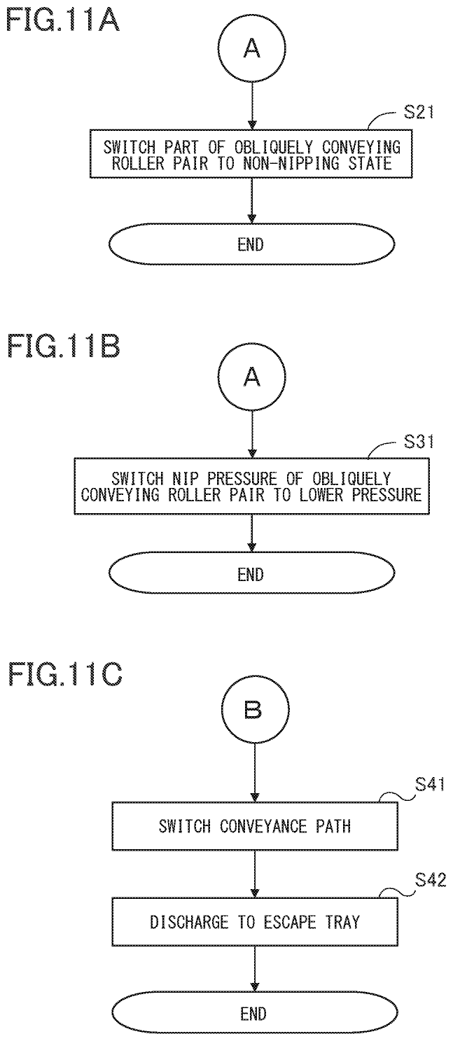

In a case where it is judged at STEP S12 that the abutment movement has been completed, as shown in FIG. 11A, the controller 100 switches a part of the obliquely conveying roller pairs 701 to 703 to the non-nipping state by the obliquely conveying detachment units 711, 721, and 731 (STEP S21). Then, the controller 100 conveys the sheet S to the registration roller pair 7 by the obliquely conveying roller pairs which are kept in the nipping state. That is, a conveyance force, in the width direction W, by the obliquely conveying roller pairs 701, 702, and 703 becomes smaller than that in the abutment movement.

Herewith, it is possible to reduce an abutment force of the sheet S on the abutment surface 750a, and prevent the sheet S from excessively abutting on the reference member 750. Therefore, it is possible to reduce a force that the sheet S receives from the abutment surface 750a of the reference member 750, and suppress the image defects by reducing a damage to and the bent of the sheet S.

### Third Embodiment

While a third embodiment will be described next, the third embodiment is different from the first embodiment only in the control performed at the time of the completion of the abutment movement. Therefore, configurations similar to the first embodiment will be described by omitting illustrations or by putting the same reference characters on drawings.

In a case where it is judged at STEP S12 that the abutment movement has been completed, as shown in FIG. 11B, the controller 100 performs a control so that a part or all of the obliquely conveying roller pairs 701, 702, and 703 reduce nip pressure (STEP S31). For example, the controller 100 performs a separating action of moving the roller portion 701b of the obliquely conveying roller pair 701 in a separating direction from the roller portion 701c (refer to FIG. 1). Such separating action is an action of reducing the nip pressure at the nip between the roller portion 701b and the roller portion 701c from the first pressure at the time of the abutment movement to the second pressure, that is lower than the first pressure, without releasing the nip. That is, a conveyance force, in the width direction W, by the obliquely conveying roller pairs 701, 702, and 703 becomes smaller than that in the abutment movement.

Herewith, the sheet S becomes easy to slip on the obliquely conveying roller pairs 701, 702, and 703, and it is possible to prevent the sheet S from excessively abutting on the reference member 750. Therefore, it is possible to reduce a force that the sheet S receives from the abutment surface 750a of the reference member 750, and suppress the image defects by reducing the damage to and the bent of the sheet S.

### Fourth Embodiment

While a fourth embodiment will be described next, the fourth embodiment is different from the first embodiment only in the control performed at the time of the completion of the abutment movement. Therefore, configurations similar to the first embodiment will be described by omitting illustrations or by putting the same reference characters on drawings.

In a case where it is judged at STEP S14 that the abutment movement has not been completed, as shown in FIG. 11C, the controller 100 drives the guide member 600 by the switching motor 610. Then, the controller 100 switches the conveyance path so as to convey the sheet S toward the escape path 600a (STEP S41).

The sheet S guided to the escape path 600a by the guide member 600 is discharged to the escape tray 601, serving as a second sheet discharge tray different from the sheet discharge tray 500 (STEP S42). Herewith, it is possible to distinguish a defectively printed sheet caused by the non-completion of the abutment movement from the sheet discharged to the sheet discharge tray 500, and possible to easily remove the sheet discharged to the escape tray 601. Therefore, it is possible to improve usability.

To be noted, while, in this embodiment, the escape tray 601 is disposed inside the printer 1, it is not limited to this. For example, it is acceptable to discharge the defectively printed sheet to the other trays disposed above or below the sheet discharge tray 500. Further, it is acceptable to discharge the defectively printed sheet to the other apparatus coupled to downstream of the printer 1.

### Other Embodiments

To be noted, while in any of the embodiments described above, the obliquely conveying roller portion 700 is disposed in front of the secondary transfer nip T2, it is not limited to this. For example, it is acceptable to apply this disclosure by disposing the obliquely conveying roller portion 700 in the other apparatus coupled to downstream of the duplex conveyance unit 502 or the printer 1.

While in any of the embodiments described above, 4 pairs of conveyance roller pairs are disposed in the conveyance roller portion 300 and 3 pairs of obliquely conveying roller pairs are disposed in the obliquely conveying roller portion, a number of roller pairs are not limited to this. Further, while the obliquely conveying roller pairs 701 to 703 each are inclined with respect to the sheet conveyance direction D1 by a similar angle, it is not limited to this, and acceptable that inclination angles with respect to the sheet conveyance direction D1 are different from each other.

Further, it is acceptable to combine the first to fourth embodiments arbitrarily. For example, when the abutment movement has not been completed, it is acceptable to perform both of displaying the message on the display part 900 (the first embodiment) and discharging the sheet to the escape tray 601 (the fourth embodiment).

While, in any of the embodiments described above, this disclosure is described taking the registration unit 800, serving as a sheet conveyance apparatus including the controller 100, as an example, it is acceptable to regard the printer 1 as the sheet conveyance apparatus.

While, in any of the embodiments described above, the descriptions are provided using the printer 1 of the electrophotographic system, the present disclosure is not limited to this. For example, it is possible to apply the present disclosure to an image forming apparatus of an ink jet system which forms the image on the sheet by ejecting a liquid ink through a nozzle.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-186739, filed Nov. 9, 2020, which is hereby incorporated by reference herein in its entirety.

What is claimed is:

1. A sheet conveyance apparatus comprising:
a conveyance roller configured to convey a sheet;
an abutment member disposed downstream of the conveyance roller and extending along a sheet conveyance direction, the abutment member comprising an abutment surface against which a side edge, in a width direction orthogonal to the sheet conveyance direction, of the sheet abuts, and configured to correct a skew of the sheet;
an obliquely conveying roller disposed downstream of the conveyance roller in the sheet conveyance direction, and configured to convey the sheet such as the side edge of the sheet is conveyed toward the abutment surface;
a sheet side edge detection portion configured to detect a position of the side edge of the sheet in the width direction and change an output value in response to the position of the side edge of the sheet conveyed by the obliquely conveying roller; and
a control unit configured to control that a conveyance force, in the width direction, by the obliquely conveying roller in response to a detection result of the sheet side edge detection portion becomes smaller than that in an abutment movement, the abutment movement being a movement in which the side edge of the sheet is brought to abut against the abutment surface by the obliquely conveying roller conveying the sheet.

2. The sheet conveyance apparatus according to claim 1, wherein, in a case where the output value of the sheet side edge detection portion has been maintained within a predetermined range during a predetermined period of time, the control unit judges that the abutment movement by the obliquely conveying roller to abut the sheet on the abutment surface has been completed.

3. The sheet conveyance apparatus according to claim 2, wherein, in a case where the control unit has judged that the abutment movement has been completed, the control unit is configured to perform a separating action of moving the obliquely conveying roller from a contact state to a separated state, and convey the sheet by the conveyance roller, the contact state being a state where the obliquely conveying roller comes into contact with the sheet, the separated state being a state where the obliquely conveying roller is separated from the sheet.

4. The sheet conveyance apparatus according to claim 2, further comprising a driven roller configured to form a nip together with the obliquely conveying roller and convey the sheet with the nip nipping the sheet,
wherein, in a case where the control unit has judged that the abutment movement has been completed, the control unit is configured to perform a separating action of releasing the nip by separating the driven roller from the obliquely conveying roller, and convey the sheet by the conveyance roller.

5. The sheet conveyance apparatus according to claim 2, further comprising a driven roller configured to form a nip together with the obliquely conveying roller and convey the sheet with the nip nipping the sheet,
wherein the control unit sets a nip pressure at the nip to a first pressure in the abutment movement, and reduces the nip pressure from the first pressure to a second pressure lower than the first pressure without releasing the nip in a case where the control unit has judged that the abutment movement has been completed.

6. The sheet conveyance apparatus according to claim 2, further comprising a display part configured to display a message on a screen,
wherein, in a case where the control unit has judged that the abutment movement has not been completed within a predetermined time after the obliquely conveying roller started conveying the sheet, the control unit displays the message on the display part to inform conveyance failure.

7. The sheet conveyance apparatus according to claim 2, wherein the sheet which the control unit has judged that the abutment movement has been completed is discharged to a first tray, and
wherein the sheet which the control unit has judged that the abutment movement has not been completed within a predetermined time after the obliquely conveying roller started conveying the sheet is discharged to a second tray that is different from the first tray.

8. The sheet conveyance apparatus according to claim 1, further comprising an image forming unit configured to form an image to the sheet.
